(19) United States
(12) Patent Application Publication
(10) Pub. No.: US 2021/0256500 A1
(43) Pub. Date: Aug. 19, 2021

(54) AUTONOMOUS MOBILE SERVICES

(71) Applicant: Diebold Nixdorf, Incorporated, North Canton, OH (US)

(72) Inventors: David William Kuchenski, Tallmadge, OH (US); Richard Harris, Warsash Southampton (DE)

(21) Appl. No.: 17/251,828

(22) PCT Filed: May 30, 2019
(86) PCT No.: PCT/US19/34615

§ 371 Date: Dec. 14, 2020

Related U.S. Application Data
(60) Provisional application No. 62/691,704, filed on Jun. 29, 2018.

(51) Int. Cl. G06Q 20/32; G06Q 10/08; G05D 1/02; B60W 60/00

(52) U.S. Cl. CPC G06Q 20/3278; B60W 60/00256; G05D 1/0276; G06Q 10/083

(57) ABSTRACT

A method of performing autonomous mobile services can include receiving, with a server, a first input corresponding to a request for mobile services, a payment account associated with a user, and an exchange location. The server can control an autonomous vehicle to move to the exchange location. An article holding unit of the vehicle can receive the user and can hold furniture or tools with radio frequency identification tags. The server can receive a second input from an authentication device positioned on the vehicle that corresponds to payment. A door to the holding unit can be opened in response to receipt of the second input. The user can then be received in the article holding unit. The autonomous vehicle can remain at the exchange location until the user has left the article holding unit.

### CROSS-REFERENCE TO RELATED APPLICATION

This application is a National Phase patent application claiming priority to International Patent Application Serial No. PCT/US19/34615 for an AUTONOMOUS MOBILE SERVICES, filed on May 30, 2019, and also claims the benefit of U.S. Provisional Patent Application Ser. No. 62/691,704 for an AUTONOMOUS MOBILE SERVICES, filed on Jun. 29, 2018, which is hereby incorporated by reference in its entirety.

### BACKGROUND

This relates in general to autonomous vehicles.

An autonomous vehicle is a vehicle capable of navigating, to at least some extent, without human input. Existing autonomous vehicle concepts may or may not require a human in the driver's seat and are usually configured to communicate with other vehicles. Typically, autonomous vehicles do not independently select a destination. Current autonomous vehicle development is directed toward producing vehicles that do not rely on special marking structures placed in the operating environment (such as magnetic strips on the driving surface). It is also desired that autonomous vehicles be able to deliver satisfactory performance despite significant uncertainties in the operating environment. Also, autonomous vehicles should have the ability to compensate, on-the-fly, for system failures without external intervention.

There are numerous benefits that are expected from autonomous vehicles. First, autonomous vehicles can communicate with one another and thereby reduce the likelihood of collisions between two vehicles. Second, a system of autonomous vehicles can be centrally-managed to reduce the likelihood of traffic congestion. The first and second benefits would result in a third benefit of reduced insurance costs. Further, autonomous vehicles will relieve travelers from driving and navigation chores, allowing travel time to be used for leisure or work. Finally, autonomous vehicles will negate the impact of distracted drivers, texting while driving, and intoxicated drivers.

An autonomous vehicle is equipped with a variety of sensors for sensing its environment. Radar, laser light, global positioning sensors (GPS), odometry, and computer vision are examples of sensing protocols applicable to autonomous vehicles. Advanced and complex control systems interpret sensory data to identify desirable navigation paths, obstacles, and relevant signage.

The Society of Automotive Engineers (SAE) has published a classification system for autonomous vehicles based on six different levels of autonomy. The classification system has been designated as J3016_201609, and titled “Taxonomy and Definitions for Terms Related to On-Road Motor Vehicle Automated Driving Systems.” The different levels of the classification system are distinguished from one another based on the extent of driver intervention and attentiveness required.

In SAE's classification system, a vehicle at Level 0 includes an automated system that issues warnings to the driver but exercises no control over the vehicle. A Level 0 vehicle is not viewed as an “autonomous vehicle” as the term is commonly used. In a Level 1 vehicle, a driver and a control system share control over the vehicle. An example of a Level 1 autonomous vehicle is a vehicle that includes Adaptive Cruise Control (ACC) in which the driver controls steering and the control system controls vehicle speed.

In a Level 2 autonomous vehicle, the control system can take full control of the vehicle, including acceleration, braking, and steering. However, the driver must monitor vehicle travel and be prepared to immediately intervene. In some vehicles, Level 2 control is implemented by forcing the driver to maintain contact with the steering wheel when the control system is otherwise controlling the vehicle.

In a Level 3 autonomous vehicle, the driver is not required to monitor the vehicle continuously during vehicle travel. The control system will automatically respond, for example, to situations such as emergency braking. However, the driver will still be called upon by the control system to intervene in some situations. An example of Level 3 autonomy is the “Traffic Jam Pilot” feature of the 2017 Audi® A8 sedan. When activated, the control system takes full control of all aspects of driving in traffic moving up to sixty kilometers per hour. The feature can only be engaged on highways with a physical barrier separating traffic moving in opposite directions.

In a Level 4 autonomous vehicle, driver attention is never required in limited areas or under special circumstances. For example, areas in which the control system of the vehicle exercises full control can be defined by geo-fencing wherein a virtual geographic boundary around an area is achieved by means of GPS or radio-frequency identification (RFID). Circumstances in which the control system of the vehicle exercises full control can include traffic jams, for example. Outside of these areas or circumstances, a Level 4 autonomous vehicle will be capable of parking if the driver does not exercise control.

In a Level 5 autonomous vehicle, no human intervention is required. An example of a Level 5 autonomous vehicle is a robotic taxi or bus.

U.S. Pub. No. 20140136414 discloses an AUTONOMOUS NEIGHBORHOOD VEHICLE COMMERCE NETWORK AND COMMUNITY. An autonomous neighborhood vehicle includes a set of wheels aligned in a pattern to provide the autonomous neighborhood vehicle stability while traversing a sidewalk, a bike lane and a roadway. The autonomous neighborhood vehicle has an electronic locking mechanism and a storage compartment which is capable of storing items. The embodiment includes a computer system of the autonomous neighborhood vehicle communicatively coupled to a commerce server of a neighborhood communication system through a wireless network to autonomously navigate the autonomous neighborhood vehicle to a destination specified by the commerce server. A navigation server of the autonomous neighborhood vehicle provides a remote sensing capability to the autonomous neighborhood vehicle such that the autonomous neighborhood vehicle is autonomously navigable to the destination.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of performing autonomous mobile services can include receiving, with at least one server computing device having one or more processors and a non-transitory, computer readable medium storing instructions, a first input from a user computing device. The first input can correspond to a request for mobile services. The first input can include a payment account associated with a user and an exchange location. The method can also include controlling, with the at least one server computing device, a control system of an autonomous vehicle having an article holding unit to move the autonomous vehicle to the exchange location in response to receiving the first input. The control system can have one or more processors and provide Level 5 control over movement of the autonomous vehicle. The method can also include sizing an interior of the article holding unit to receive the user and to define at least one of an office or a workshop. The method can also include positioning at least one of furniture or tools in the article holding unit such that the user, when received in the article holding unit, can utilize the at least one of furniture or tools. The method can also include including, with at least one of furniture or tools, at least one radio frequency identification tag. The method can also include receiving, with the at least one server computing device, at least part of a second input from an authentication device having one or more processors and positioned on the autonomous vehicle. The at least part of the second input can correspond to payment for opening at least one door of the article holding unit positioned on the autonomous vehicle. The method can also include controlling, with the at least one server computing device, at least one of the authentication device and the control system of the autonomous vehicle to open the at least one door of the article holding unit in response to receiving the at least part of the second input. The method can also include receiving the user in the article holding unit after controlling the at least one door of the article holding unit to open. The method can also include controlling, with the control system of the autonomous vehicle, the autonomous vehicle to remain at the exchange location until the user has left the article holding unit.

In other features, the receiving of the at least part of the second input from the authentication device further comprises receiving, with the at least one server computing device, a first part of the second input from the user computing device, the first part of the second input including an indication of confirmation of the account associated with the user. The receiving of the at least part of the second input from the authentication device further comprises receiving, with the at least one server computing device, a second part of the second input from the authentication device on the autonomous vehicle, the second part including confirmation of an identity of the user. The method can also include transmitting, with the at least one server computing device, the at least part of the second input to a secondary server computing device. The method can also include receiving, with the at least one server computing device, a confirmation input from the secondary server computing device, the confirmation input indicative that the at least part of the second input is authenticated. The controlling of the at least one of the authentication device and the control system of the autonomous vehicle to open the at least one door following the receiving the confirmation input from the secondary server computing device.

Various aspects will become apparent to those skilled in the art from the following detailed description and the accompanying drawings.

### BRIEF DESCRIPTION OF THE DRAWINGS

FIG. 1 is a functional block diagram of an exemplary system according to one or more implementations of the present disclosure;

FIG. 2 is a schematic block diagram of an exemplary autonomous vehicle according to one or more implementations of the present disclosure; and

FIG. 3 is a flow diagram of an exemplary method executed by a system according to one or more implementations of the present disclosure.

### DETAILED DESCRIPTION

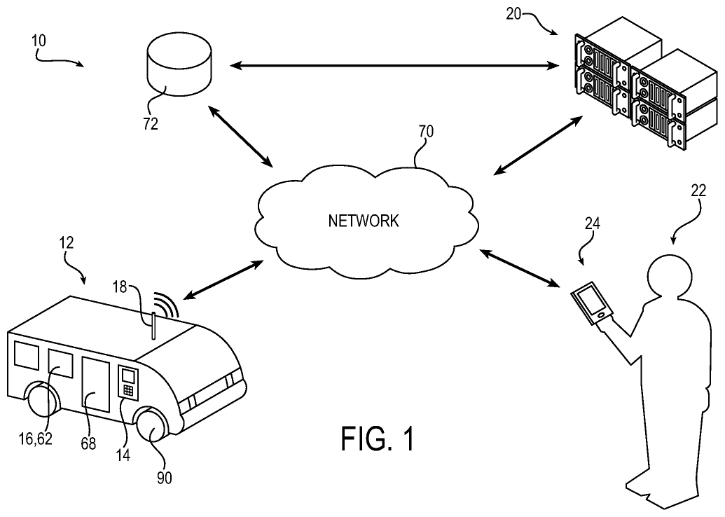

Referring now to FIG. 1, a system 10 is configured to perform autonomous mobile services. The exemplary system 10 includes an autonomous vehicle 12, an authentication device 14 positioned on the autonomous vehicle 12, an article holding unit 16 positioned on the autonomous vehicle 12, a transceiver 18 positioned on the autonomous vehicle 12, and at least one server computing device 20. The at least one server computing device 20 of the system 10 can receive a request from a user 22 for at least one autonomous mobile service. The desired service can be provided by the autonomous vehicle 12. Various kinds of services that can be provided in one or more implementations of the present disclosure are set forth in greater detail below.

The user 22 can communicate the request for service to the at least one server computing device 20 with a computing device such as a smart phone 24. Other types of computing devices can be used as well, such as tablets, desktop computers, and smart televisions, for example. The request can include an indication of a desired exchange location and an account for payment. The user computing device 24 can be operating a computer application (an “app”) at least partially controlled by the server computing device 20. The system 10 may provide one type of service or more than one type of service. In implementations in which the system 10 provides more than one type of service, the first input would include an indication of the type of service requested. The indication of the payment account in the first input (the initial request) can be viewed as the first part of an authentication process having two or more parts. A second part of the authentication process can involve confirming that the user 22 has additional information associated with the payment account, such as a personal identification number (PIN) or biometric data such as a fingerprint or iris scan. In response to the request for service defined by the first input, the at least one server computing device 20 can transmit a command to the autonomous vehicle 12 to travel to the exchange location. When the autonomous vehicle 12 reaches the exchange location, the user 22 can utilize the authentication device 14 to complete the authentication process. In response to completion of the authentication process, the system 10 can control a door 62, which closes the article holding unit 16, to open.

In one or more implementations of the present disclosure, the article holding unit 16 may hold an article that the user takes possession of when the article holding unit 16 opens. In one or more other implementations of the present disclosure, the article holding unit 16 may hold an article that the user utilizes within the article holding unit 16 when the article holding unit 16 opens. In one or more other implementations of the present disclosure, the article holding unit 16 may hold an article that the user removes from the article holding unit 16 when the article holding unit 16 opens, uses the article, and then returns to the article holding unit 16 when finished with the article. In one or more other implementations of the present disclosure, the article holding unit 16 may receive an article from the user when the article holding unit 16 opens and transport the article away from the exchange location.

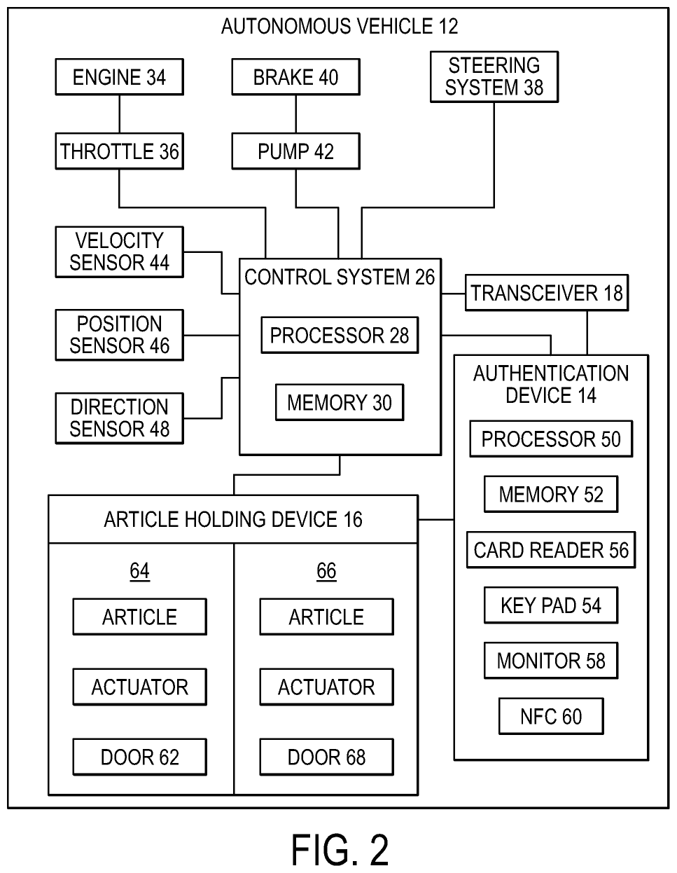

Referring now to FIG. 2, the exemplary autonomous vehicle 12 includes a control system 26 having one or more processors 28 and a non-transitory, computer readable medium in the form of memory 30. The exemplary control system 26 is configured to provide Level 5 control over movement of the autonomous vehicle 12. Exemplary processor 28 includes at least one microprocessor coupled to a memory 30, which may represent the random access memory (RAM) devices comprising the main storage of processor 28, as well as any supplemental levels of memory, e.g., cache memories, non-volatile or backup memories (e.g., programmable or flash memories), read-only memories, etc. The memory 30 may be considered to include memory storage physically located in processor 28, e.g., any cache memory in a processor in CPU, as well as any storage capacity used as a virtual memory, such as stored on a mass storage device or on another computer or electronic device coupled to processor 28. Memory 30, in other implementations, may also include one or more mass storage devices, e.g., a floppy or other removable disk drive, a hard disk drive, a direct access storage device (DASD), an optical drive (e.g., a CD drive, a DVD drive, etc.), and/or a tape drive, among others. Processor 28 operates under the control of an operating system, kernel and/or firmware and executes or otherwise relies upon various computer software applications, components, programs, objects, modules, data structures, etc. Moreover, various applications, components, programs, objects, modules, etc. may also execute on one or more processors in another computer coupled to processor 28, e.g., in a distributed or client-server computing environment, whereby the processing required to implement the functions of a computer program may be allocated to multiple computers over a network.

The exemplary autonomous vehicle 12 includes a chassis 32. Wheels are mounted on the chassis, as referenced in FIG. 1 at 90. The autonomous vehicle 12 can also include an engine 34 and a throttle 36 controlling the output of the engine 34. The engine 34 is mounted on the chassis 32 and provides power to the wheels of the autonomous vehicle 12. The engine 34 can convert electrical power to motion for driving the wheels, can generate power through internal combustion (IC), or can be a dual mode or hybrid system in which electrical and IC power is utilized. The control system 26 can control the throttle 36 to selectively change the position of the throttle 36 and thereby change the acceleration of the vehicle 12.

The exemplary autonomous vehicle 12 also includes a steering system 38 engaged with at least one of the wheels to steer the autonomous vehicle 12 in a desired direction. The control system 26 can control the steering system 38 to selectively change the direction of travel of the vehicle 12. The exemplary autonomous vehicle 12 also includes a braking system including at least one brake 40 and a pump 42 for delivering fluid to the brake 40. The braking system is engaged with at least one of the wheels and is operable to decelerate the autonomous vehicle 12. The control system 26 can control the pump 42 to selectively reduce the velocity of the vehicle 12.

The exemplary autonomous vehicle 12 also includes at least one velocity sensor 44 configured to detect a velocity of the vehicle 12. The exemplary velocity sensor 44 is disposed to communicate, to the control system 26, a velocity signal corresponding to the sensed velocity of the vehicle 12. The exemplary autonomous vehicle 12 also includes at least one position sensor 46 configured to detect a geographic position of the vehicle 12. The exemplary position sensor 46 is disposed to communicate, to the control system 26, a sensed position signal corresponding to the geographic position (such as a signal from a Global Positioning Sensor) of the vehicle 12. The exemplary autonomous vehicle 12 also includes at least one direction sensor 48 configured to detect a cardinal direction (such as North, South, etc) of the vehicle 12. For example, the direction of the vehicle 12 can be defined as the direction from the rear end of the vehicle 12 toward the forward end of the vehicle 12. The exemplary direction sensor 48 is disposed to communicate a direction signal to the control system 26 and the direction signal corresponds to the cardinal direction of the vehicle 12. The control system 26 can receive the signals received from the sensors 44, 46, 48 and, in response to those signals and in accordance with algorithms stored in memory 30, control the movement of the vehicle 12 to travel to the exchange location.

The exemplary authentication device 14 includes one or more processors, such as processor 50, and a non-transitory, computer readable medium, such as memory 52. When the autonomous vehicle 12 reaches the exchange location, the authentication device 14 is utilized to complete the authentication process. The authentication device 14 is utilized to confirm the payment account and to confirm that the person at the exchange location is the user 22 who has authority over the payment account identified in the request for services. In one example, the authentication device 14 can be an automated transaction machine (ATM) and include a key pad 54, a card reader 56, and a monitor 58. The card reader 56 can receive a card from the user 22 to confirm the payment account associated with the request for services. The user 22 can enter a PIN through the key pad 54 to confirm that the user 22 engaged with the authentication device 14 can authorize payment against the account. In one or more other examples, the authentication device 14 can include a near field communication (NFC) device 60. The NFC device 60 can communicate with the smartphone 24 to confirm the payment account associated with the request for services. For example, an app operating on the smart phone 24, such as a banking app, can communicate an account associated with the smart phone 24 to the NFC device 60 of the authentication device 14 and this information can be further transmitted to the server computing device 20 during the authentication process. Further, other approaches can be applied to confirm the account and/or to confirm the authority of the user 22, such as geo-fencing, biometrics, and Bluetooth beacons, by way of example and not limitation.

The article holding unit 16 is positioned on the autonomous vehicle 12 and includes at least one door 62 operable to open and close. The exemplary article holding unit 16 includes a plurality of isolated compartments 64, 66 and a respective door 62, 68 for each of the compartments 64, 66. Respective actuators 61, 67 can be positioned to open the respective doors 62, 68. The actuators 61, 67 can be controlled by at least one of the authentication device 14 and/or the control system 26. The one or more compartments 64, 66 of the article holding unit 16 can be any size. The size of the one or more compartments 64, 66 of the article holding unit 16 can be selected in view of the service(s) provided by the vehicle. Various implementations of the present disclosure are described in greater below and these implementations demonstrate different sizes for the one or more compartments 64, 66 of the article holding unit 16. The doors 62, 68 are thus under the control of at least one of the authentication device 14 and/or the control system 26.

The transceiver 18 is configured to receive and transmit wireless communications. The transceiver 18 can be in direct communication with both the authentication device 14 and the control system 26. Alternatively, the transceiver 18 can be in direct communication with one of the authentication device 14 and the control system 26, and in indirect communication with the other. By way of example and not limitation, the transceiver 18 can be in direct communication with the control system 26 and communicate with the authentication device 14 through the control system 26. The transceiver 18 can transmit messages originating from the authentication device 14 or from the control system 26. The transceiver 18 can receive messages and direct received messages to the authentication device 14 or to the control system 26.

Referring again to FIG. 1, the at least one server computing device 20 can include one or more processors and be remote from the autonomous vehicle 12. The at least one server computing device 20 is configured to exchange wireless communications with the transceiver 18 to communicate with the authentication device 14 and the control system 26. The at least one server computing device 20 can communicate with the transceiver 18 over a network 70. The network 70 can include a local area network (LAN), a wide area network (WAN), e.g., the Internet, a mobile phone network, or any combination thereof. The present disclosure is well suited to a wide variety of network systems over numerous topologies.

The system 10 can also include a database 72. The database 72 is accessible by the at least one server computing device 20. The server computing device 20 can access the database 72 over the network 70 or can access the database 72 directly. The database 72 can store financial records of the user 22. In addition or alternatively, the database 72 can store the data indicating the contents of each of the compartments 64, 66. In addition or alternatively, the database 72 can store previous transactions of the user, such as previous uses of the vehicle 12 and previous articles purchased. The database 72 can also store current promotions associated with any of articles previously purchased by the user 22. It is noted that a single database 72 is disclosed in the exemplary implementation, but more than one database can be included in other implementations of the present disclosure.

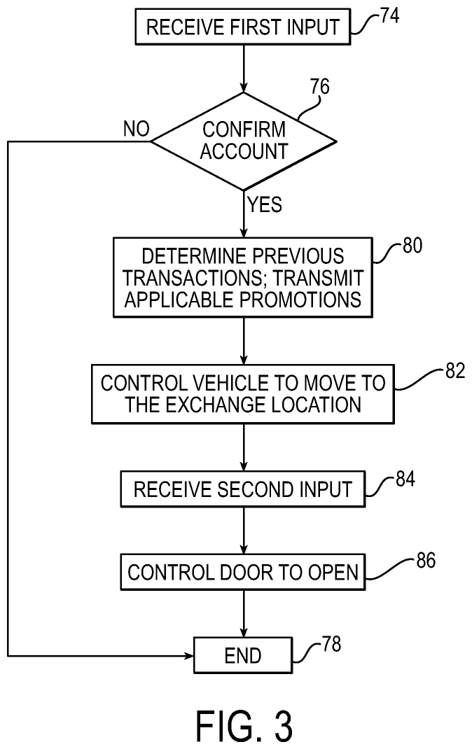

The at least one server computing device 20 also includes a non-transitory, computer readable medium storing instructions that, when executed by the one or more processors of the at least one server computing device 20, cause the at least one server computing device 20 to perform operations directed to autonomous mobile services. FIG. 3 is a flow diagram of an exemplary method executed by the system 10 according to one or more implementations of the present disclosure.

At 74, a consumer can create a mobile account. The account can be established by the user 20 with the server computing device 20, whereby various data is stored with the server computing device 20. The data stored by the server computing device 20, by way of example and not limitation, can include one or more payment methods of the user 20, the identity of the user 20, and the physical address and other forms of contact information for the user 20. The data that is associated with the user and stored can increase over time.

When the autonomous mobile services are utilized, the user can request autonomous service to a location. This request can be referred to as a first input. At 76, the at least one server computing device 20 can receive the first input from a user computing device. The first input can include the name of the user, the user's account, and the nature of the desired autonomous services, for example. The user computing device 24 is remote from the server computing device 20. The user computing device can be a smart phone 24. The smart phone 24 can be operating an app at least partially controlled by the operator of the server computing device 20. Alternatively, the smart phone 24 can communicate with the server computing device 20 through a browser. The request from the user 20, the first input, can also include an indication of the timing desired by the user 20. For example, the first input can include an indication of whether the autonomous services are requested as soon as possible or at a scheduled time in the future.

The first input can include a desired exchange location. The first input can include an identification of an account of the user 22, such as an account for payment of the autonomous mobile services. The identification of the account can be viewed as a first or preliminary part of an authentication process for confirming that the user 22 has the authority to approve a charge against the account for the autonomous mobile service. In one or more implementations of the present disclosure wherein the system 10 provides different types of mobile services, the first input can also be indicative of the type of service desired.

In the present implementation of the present disclosure, the system 10 can continue the process of providing autonomous mobile services upon receipt of the first input without requiring further information to authenticate the user 22. In one or more other implementations of the present disclosure, the system 10 may require further information or may exercise further measures to authenticate the user 22 before the process is continued. For example, the server computing device 20 can access the database 72 containing financial records of the user 22 in response to receipt of the first input, such as to ensure the user has the capacity to pay for the autonomous mobile services that are requested.

At 78, in one or more implementations of the present disclosure, the system can determine the location of the user computing device 24 and suggest an exchange location. The server computing device 20 can communicate with the user computing device 24 directly and receive the location of the user computing device 24. Based on the location data, the server computing device 20 can recommend the exchange location. Even if the user 22 requests a specific exchange location, the server computing device 20 can recommend an alternative exchange location. For example, the server computing device 20 can store in memory data related to criminal activity and public safety. If the user 22 proposes an exchange location in an area of relatively high crime, the server computing device 20 can recommend an exchange location proximate to the user-desired exchanged location but in an area with relatively low crime.

At 80, the system 10 can communicate to the user computing device 24 an estimated arrival time. The server computing device 20 can communicate with the autonomous vehicle 12 and receive the location of the autonomous vehicle 12. Based on the location of the autonomous vehicle 12 and the exchange location, the server computing device 20 can determine the travel time of the autonomous vehicle 12 to the exchange location. The server computing device 20 can then communicate an expected arrival time of the autonomous vehicle 12 at the exchange location to the user computing device 24.

At 82, the at least one server computing device 20 can control the control system 26 of the autonomous vehicle 12 to move the autonomous vehicle 12 to the exchange location in response to receiving the first input at 76. It is noted that the commands originating from the server computing device 20 can be received directly by the control system 26 through the transceiver 18. Alternatively, the commands originating from the server computing device 20 can be received indirectly by the control system 26, from the authentication device 14 after the authentication device 14 has received the commands through the transceiver 18. Thus, in one or more other implementations of the present disclosure, the control system 26 is slave to the authentication device 14.

When the vehicle 12 reaches the exchange location, the user 22 can enter further information through the authentication device 14. Information can be communicated to the authentication device 14 by the user 22 in various ways. In one example, the first input can be communicated by the insertion of a card in the card reader 56 of the exemplary authentication device 14. In another example, the first input can be communicated by the computing device 24 of the user 22. For example, the user 22 can tap the NFC device 60 with the smart phone 24 to exchange data about the payment account. In another example, Bluetooth beacons can be positioned on the vehicle 12 and communicate with the authentication device 14. In another example, biometric sensors can be positioned on the vehicle 12 and communicate with the authentication device 14. For example, the user 22 can position his/her face before a facial scanner positioned on the vehicle 12. The facial scanner can transmit the data generated by a facial scan of the user 22 to the authentication device 14. In another example, authentication can occur through another form of biometrics, such as entering a fingerprint through a banking app on the user computing device 24.

The authentication device 14 can generate a second input in response to receiving authentication information from the user 22 at the exchange location. The information received by the authentication device 14 can include a first part being a payment account associated with the user 22. The information received by the authentication device 14 can also include a second part being information associated with the user 22 that authenticates the authority of the person at the exchange location to permit a charge to the payment account for the mobile autonomous services, such as a PIN. The first and second parts of the information received by the authentication device 14 can be the information included in the second input. In one or more other implementations of the present disclosure, the second input can include only the second part of the information received by the authentication device 14, for example the PIN.

At 84, the server computing device 20 receives the second input from the authentication device 14. In one or more implementations of the present disclosure, the second input can be directed from the authentication device 14 through the control system 26 of the autonomous vehicle 12 and to the server computing device 20. Thus, in one or more other implementations of the present disclosure, the authentication device 14 can be a slave to the control system 26. Alternatively, the second input can be transmitted from the authentication device 14 directly to the server computing device 20 through the transceiver 18.

At 86, the information included in the second input is assessed by the server computing device 20 to confirm the authority of the user 22 and the availability of the payment account. The server computing device 20 can confirm that the account of the user 22 holds sufficient funds for the charge for the autonomous mobile service. When the data in the database 72 indicates that the account of the user 22 does not hold sufficient funds for the charge for the autonomous mobile service, the process ends at 92. For example, the server computing device 20 can control the vehicle 12 to leave the exchange location.

When the data in the database 72 indicates that the account of the user 22 does hold sufficient funds for the charge for the autonomous mobile service, the payment for the service can be processed. The second input thus corresponds to payment for the autonomous mobile service since the payment is processed upon confirming the information that was included in the second input. The payment can be processed immediately upon confirming the information included in the second input, after some other additional step(s) are taken, or after some predetermined period of time.

When the data in the database 72 indicates that the account of the user 22 does hold sufficient funds for the charge for the autonomous mobile service, the exemplary process continues to step 88. At 88, the server computing device 20 can access the database 72 to determine previous transactions of the user 22. Each of the previous transactions involves at least one respective article. The server computing device 20 can further access the database 72 to determine if any current promotion is associated with any of the articles involved in the previous transactions. The server computing device 20 can further transmit any current promotions to the user 22 at 88. It is noted that in other implementations of the present disclosure, data of previous transactions of the user 22 and of promotions may be held in one or more databases other than database 72. For example, one database may hold previous transactions and another database may hold current promotions.

In response to receipt of any promotions, the user 22 may modify the first input to include additional services. As set forth above, the service requested may be the delivery of an article held by the article holding unit 16, wherein the user 22 takes possession of the article when one of the doors 62, 68 opens. In response to a promotion, the user 22 may request additional articles. In another example, the service requested may be the use of an article held in the article holding unit 16, wherein the user 22 utilizes the article within the article holding unit 16 and the service ends when the user 22 leaves the article holding unit 16. In response to a promotion, the user 22 may request additional articles be placed in the article holding unit 16. Alternatively, the server computing device 20 can control another vehicle, similar to vehicle 12 but with more articles, to the exchange location. Alternatively, the service that is requested may involve the user 22 removing the article from the article holding unit 16, utilizing the article outside of the article holding unit 16, and returning the article to the article holding unit 16. In response to a promotion, the user 22 may request additional articles be placed in the article holding unit 16 or that additional doors to other article holding units will open or that additional vehicles will be sent to the exchange location. In one or more other implementations of the present disclosure, the service requested may be removal of an article possessed by the user 22. In response to a promotion, the user 22 may advise the server computing device 20 that additional articles will be placed in the article holding unit 16 when the vehicle 12 arrives at the exchange location. Thus, implementations of the present disclosure can be practiced in which promotions are presented to the user 22, accepted by the user 22, and the service provided to the user is modified after receipt of the first input.

It is noted that in one or more other implementations of the present disclosure, the at least one server computing device 20 can access the database 72 or another database containing financial records of the user 22 in response to the first or second input. Thus, step 86 could occur before step 80. In one or more embodiments, the authentication device 14 can be configured to accept payment by banknote (cash). In such embodiments, step 86 can be omitted. When the server computing device 20 determines that the payment account will not suffice for payment for the service, the server computing device 20 can transmit a message to the user 22, displayed on the monitor 58. The message can advise the user 22 of the deficiency of the payment account and permit the user 22 to pay for the service by banknote(s). In response to the message, the user 22 can submit the appropriate banknote(s) to the authentication device 14 to receive the service.

In one or more implementations of the present disclosure, the server computing device 20 may access the database 72 or complete authentication with another server computing device. For example, the server computing device 20 may not be associated with the bank that maintains the payment account of the user 22. The provider of the service and the financial institution maintaining the payment account may be different entities. In such an implementation, the at least one server computing device 20 of the service provider can transmit at least part of the first input to a secondary server computing device for confirmation of the data received as part of either input. The secondary server computing device can access a database to determine if the account holds sufficient funds for the charge for the autonomous mobile service. The response received by the server computing device 20 from the secondary server computing device can be a confirmation input confirming that the account can be charged for the autonomous mobile service, or a rejection input indicating otherwise.

At 90, the at least one server computing device 20 can control the door of the article holding unit 16 to open. This allows the user 22 to receive the service. In various implementations, the server computing device 20 can control the authentication device 14 or the control system 26 to open the at least one door 62 of the article holding unit 16. The door is opened in response to the server computing device 20 receiving the second input. In various implementations, either the authentication device 14 or the control system 26 can control the article holding unit 16. Sensors can be mounted on the article holding unit 16 to determine when the door 62 can be closed and the vehicle 12 can leave the exchange location. Upon receiving the services/goods, the consumer/user 22 moves away from the vehicle and is charged for services/goods. The method ends at 92. The vehicle 12 then proceeds to the next scheduled appointment.

Various kinds of services can be provided in implementations of the present disclosure. In one implementation, bank notes can be positioned in the article holding unit 16. In such an implementation, the article holding unit 16 defines a cash box and dispensing device. The authentication device 14 and the article holding unit 16 cooperatively define an ATM. The article holding unit 16 can include appropriate structures and mechanisms to effectuate cash dispensing. In operation, the user 22 can request a cash withdrawal and the vehicle 12 can bring the ATM to the user 22 at the exchange location to dispense banknotes.

In another implementation of the present disclosure, edible products such as food and beverages can be positioned in the article holding unit 16. In such an implementation, the article holding unit 16 can include appropriate structures and mechanisms to effectuate cooling or heating of the edible products. The different compartments 64, 66 can contain different kinds of edible products. Alternatively, different kinds of edible products can be contained in a single compartment and the article holding unit 16 can include structures and mechanisms such as found in vending machines to dispense one or more particular edible products to the user 22.

In another implementation of the present disclosure, medication can be positioned in the article holding unit 16. In such an implementation, the article holding unit 16 can include appropriate structures and mechanisms to effectuate temperature and humidity control within the compartment(s). The different compartments 64, 66 can contain different kinds of medication. Alternatively, different kinds of medication can be contained in a single compartment and the article holding unit 16 can include structures and mechanisms such as found in vending machines to dispense one or more particular medications to the user 22.

In another implementation of the present disclosure, furniture, tools or some other item can be positioned in the article holding unit 16. In such an implementation, the service provided to the user 22 can be the permanent transfer of the article to the user 22 or the utilization of the furniture by the user 22 within the article holding unit 16 or outside of the article holding unit 16. For example, when the article is furniture, the furniture can be utilized within the article holding unit 16 and the article holding unit 16 can receive the user 22. The user 22 can enter the article holding unit 16 through the exemplary door 68. The interior of the article holding unit 16 can define a mobile office and/or meeting space. The control system 26 of an autonomous vehicle 12 can control the autonomous vehicle 12 to remain at the exchange location until the user 22 has left the article holding unit 16. In another example, the interior of the article holding unit 16 can be a workshop and tools can be held in the article holding unit 16. The user 22 can enter the article holding unit 16 with a workpiece and utilize the tools on the workpiece. An implementation of the present disclosure can thus be a mobile workshop. Tools in the article holding unit 16 can include radio frequency identification tags to ensure that the tools are not taken from the article holding unit 16.

In another implementation of the present disclosure, furniture, tools or some other item can be positioned in the article holding unit 16 and the service provided to the user 22 can be the delivery of the item for temporary utilization of the item by the user 22 outside of the article holding unit 16. The vehicle 12 may remain at the exchange location until the user 22 has finished using the item or can leave the exchange location after the user 22 has removed the item from the article holding unit 16.

In another implementation of the present disclosure, the article holding unit 16 may receive an article from the user 22 after the door 62 or 68 of the article holding unit 16 has opened. In such an implementation, the user 22 may be returning an article previously received from the vehicle 12 or a similar vehicle. Alternatively, the user 22 may be dispensing of unwanted refuse. The refuse may be recyclable material and the article holding unit 16 can include compartments for various kinds of material, such as one compartment for paper, one compartment for plastics, and one compartment for cardboard. The refuse may be material that cannot be received at a landfill, such as paint, medication, and petroleum products.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein is hereby unconditionally reserved. The use of the word “can” in this document is not an assertion that the subject preceding the word is unimportant or unnecessary or “not critical” relative to anything else in this document. The word “can” is used herein in a positive and affirming sense and no other motive should be presumed. More than one “invention” may be disclosed in the present disclosure; an “invention” is defined by the content of a patent claim and not by the content of a detailed description of an embodiment of an invention.

What is claimed is:

1. A system for performing autonomous mobile services, comprising:
an autonomous vehicle including a control system having one or more processors and a non-transitory, computer readable medium, said control system providing Level 5 control over movement of said autonomous vehicle;
an authentication device having one or more processors and a non-transitory, computer readable medium, said authentication device positioned on said autonomous vehicle;
at least one article holding unit positioned on said autonomous vehicle, said at least one article holding unit having at least one door operable to open and close, said at least one door under the control of at least one of said authentication device and said control system;
a transceiver positioned on said autonomous vehicle and configured to receive and transmit wireless communications, said transceiver in communication with said authentication device and said control system; and
at least one server computing device, having one or more processors and remote from said autonomous vehicle and configured to exchange wireless communications with said transceiver, said at least one server computing device further comprising a non-transitory, computer readable medium storing instructions that, when executed by the one or more processors of said at least one server computing device, cause said at least one server computing device to perform operations comprising:
receiving a first input from a user computing device, the user computing device remote from said at least one server computing device, the first input indicative of a request for autonomous mobile services and including an exchange location and a payment account associated with the user,
controlling said control system of said autonomous vehicle to move said autonomous vehicle to the exchange location in response to receiving the first input,
receiving at least part of a second input from said authentication device, the second input corresponding to payment for opening said at least one door of said at least one article holding unit, and
controlling said at least one of said authentication device and said control system of said autonomous vehicle to open said at least one door of said at least one article holding unit in response to receiving the second input.

2. The system of claim 1 wherein said authentication device is further defined as an automated transaction machine and further comprises:
a key pad;
a card reader; and
a display screen.

3. The system of claim 1 wherein said authentication device further comprises:
a near field communication device.

4. The system of claim 1 further comprising:
a database, accessible by said at least one server computing device, said database storing financial records of the user.

5. The system of claim 1 further comprising:
bank notes positioned in said at least one article holding unit.

6. The system of claim 1 further comprising:
edible products positioned in said at least one article holding unit.

7. The system of claim 1 further comprising:
medication positioned in said at least one article holding unit.

8. The system of claim 1 further comprising:
furniture positioned in said at least one article holding unit.

9. The system of claim 1 wherein said at least one article holding unit further comprises a plurality of distinct compartments isolated from one another and said at least one door further comprises a plurality of doors including a respective door for each of said compartments.

10. The system of claim 9 further comprising:
a database, accessible by said at least one server computing device, said database storing contents of each of said compartments.

11. A method of performing autonomous mobile services, comprising:
receiving, at at least one server computing device having one or more processors and a non-transitory, computer readable medium storing instructions, a first input from a user computing device, the first input corresponding to a request for mobile services, the first input including a payment account associated with the user and an exchange location;
controlling, with the at least one server computing device, a control system of an autonomous vehicle to move the autonomous vehicle to the exchange location in response to receiving the first input, the control system having one or more processors and providing Level 5 control over movement of the autonomous vehicle;
receiving, with the at least one server computing device, at least part of a second input from an authentication device having one or more processors and positioned on the autonomous vehicle, the at least part of the second input corresponding to payment for opening at least one door of at least one article holding unit positioned on the autonomous vehicle; and
controlling, with the at least one server computing device, at least one of the authentication device and the control system of the autonomous vehicle to open the at least one door of the at least one article holding unit in response to receiving the at least part of the second input.

12. The method of claim 11 further comprising:
accessing, with the at least one server computing device, a database containing financial records of the user, in response to the first input and prior to said controlling the control system of the autonomous vehicle to move the autonomous vehicle to the exchange location.

13. The method of claim 11 further comprising:
accessing, with the at least one server computing device, a database containing financial records of the user, in response to the first input and prior to said controlling the at least one of the authentication device and the control system of the autonomous vehicle to open the at least one door and after said controlling the control system of the autonomous vehicle to move the autonomous vehicle to the exchange location.

14. The method of claim 11 wherein said receiving the at least part of the second input from the authentication device further comprises:
receiving, with the at least one server computing device, a first part of the second input from the user computing device, the first part of the second input including an indication of confirmation of the account associated with the user; and
receiving, with the at least one server computing device, a second part of the second input from the authentication device on the autonomous vehicle, the second part including confirmation of an identity of the user.

15. The method of claim 11 further comprising:
determining, with the at least one server computing device, previous transactions of the user, each of the previous transactions involving at least one respective article;
determining, with the at least one server computing device, a current promotion associated with at least one of the respective articles involved in the previous transactions; and
transmitting, with the at least one server computing device, the current promotion to the user computing device prior to said receiving the at least part of the second input from the authentication device.

16. The method of claim 11 further comprising:
directing the at least part of the second input from the authentication device through the control system of the autonomous vehicle.

17. The method of claim 11 further comprising:
transmitting, with the at least one server computing device, the at least part of the second input to a secondary server computing device; and
receiving, with the at least one server computing device, a confirmation input from the secondary server computing device, the confirmation input indicative that the at least part of the second input is authenticated, said controlling the at least one of the authentication device and the control system of the autonomous vehicle to open the at least one door following said receiving the confirmation input from the secondary server computing device.

18. The method of claim 11 further comprising:
receiving the user in the at least one article holding unit after said controlling the at least one door of the at least one article holding unit to open.

19. The method of claim 18 further comprising:
controlling, with the control system of an autonomous vehicle, the autonomous vehicle to remain at the exchange location until the user has left the at least one article holding unit.

20. The method of claim 11 further comprising:
receiving an article in the at least one article holding unit after said controlling the at least one door of the at least one article holding unit to open.
